(19) United States
(12) Patent Application Publication
(10) Pub. No.: US 2008/0020766 A1
(43) Pub. Date: Jan. 24, 2008

(54) Method for selecting base station and communication system using the same

(75) Inventors: Chun-Jen Chen, Taipei City (TW); Ching-Yu Lin, Hsinchu City (TW)

Correspondence Address: RABIN & Berdo, PC, 1101 14TH STREET, NW, SUITE 500, WASHINGTON, DC, 20005, US

(73) Assignee: BenQ Corporation, Taoyuan Shien (TW)

(21) Appl. No.: 11/826,878

(22) Filed: Jul. 19, 2007

(30) Foreign Application Priority Data
Jul. 21, 2006 (TW) 095126823

(51) Int. Cl. H04Q 7/20

(52) U.S. Cl. 455/435.2

(57) ABSTRACT

A method for selecting a base station is applied to a mobile station. The mobile station sets a preset distance corresponding to a datum base station. The method comprises selecting a first base station to be a serving base station; and obtaining a first C2 parameter of a second base station corresponding to the mobile station, and obtaining a second C2 parameter as a base for the mobile station in selecting the serving base station when a distance between the second base station and the datum base station is determined to be smaller than the preset distance, wherein the second C2 parameter is equal to the first C2 parameter plus a threshold value.

This application claims the benefit of Taiwan application Serial No. 95126823, filed Jul. 21, 2006, the subject matter of which is incorporated herein by reference.

### BACKGROUND OF THE INVENTION

1. Field of the Invention

The invention relates in general to a method for selecting a base station and a communication system using the same, and more particularly to a method for selecting a base station so as to extend a homezone service and communication system using the same.

2. Description of the Related Art

In a communication system, such as a cellular network, the geographical area of a metropolis is normally divided into a number of base station cells. Several base stations are connected to a mobile service switch center (MSC), which is connected to a public switched telephone network (PSTN). Users (mobile clients) of the cellular network communicate with the surrounding base stations and datum base station by using a hand-held device or a device installed on a car (mobile station). The base station communicating with the mobile station is called a serving base station.

However, cell selection of the mobile station for selecting a suitable base station as a serving base station requires parameters C1 and C2 for determination. The parameters C1 and C2 are set up according to the global system for mobile communication (GSM) standard. The C1 parameter is a path loss criterion and the C2 parameter is a cell reselection criterion. For the mobile station, the best serving base station is considered to have a positive C1 parameter and the highest C2 parameter. Therefore, when the mobile station detects a higher C2 parameter, it changes to use the base station with the higher C2 parameter as the serving base station. As regulated by the ETSI 05.08, the C1 parameter is defined as bellows:

C1=(A−Max(B,0)); wherein

A=RLA_C−RXLEV_ACCESS_MIN;

RLA_C is an average power of carrier waves of a signal;

RXLEV_ACCESS_MIN is a minimum signal intensity with which a mobile station can connect to the communication system;

B=MS_TXPWR MAX_CCH−P;

MS_TXPWR_MAX_CCH is a maximum of a broadcast control channel without power control;

P is a maximum output power of the mobile station.

If a certain base station has the C1 parameter larger than 0, it represents the base station can be selected by the mobile station to be the serving base station and the base station with the maximum C1 parameter is selected to be the serving base station the mobile station registers in. If the mobile station is in a mobile state (the detected C1 parameter of the serving base station may be changed), or the selected serving base station rejects communication, the C2 parameter should be used for determining whether the selected serving base station is suitable. The C2 parameter is defined as bellows:

C2=C1+CELL_RESELECTION_OFFSET−TEMPORARY OFFSETH×(PENALTY_TIME−T);

Equal to PENALTY_TIME< >11111

Wherein for other base stations not selected to be the serving base station, H(x)=0 for x<0
=1 for x≧0;

For the base station area operating in service,

H(x)=0.

The homezone service is mainly provided for the users to register with the network proprietor beforehand to obtain a lower payment or better service in a limited range. The setting method is to set a starting point first and the starting point is usually a datum base station in an area. The user also registers with the network proprietor to have a preset distance and the circular area with a center at the datum base station and a radius equal to the preset distance is the user's homezone provided by the network proprietor. When the mobile station obtains the position coordinates of the serving base station through broadcast of the serving base station, if the serving base station is located in the homezone, the user can have a premium of payment or various services. Inversely, if its position coordinates do not belong to the homezone, the user is charged by a normal rating. In this way of arrangement, the users operating in the same area most of the time can be attracted to order this kind of service, which increases more clients for the system proprietor.

In the above conventional method, the mobile station uses the position coordinates of the serving base station as its own position coordinates for calculating its distance with the datum base station. However, when the mobile station is located at the edge of the homezone, it may be still located within the preset distance but select to communicate with the base stations not located in the homezone, and consequently, the users cannot use thoroughly the whole homezone provided by the network proprietor, and even have unnecessary dispute. Referring to FIG. 1, a schematic diagram of a conventional homezone service is shown. In FIG. 1, the homezone is a circular area centered at the datum base station and having a radius of the preset distance R.

The mobile station may register a first base station 101, a second base station 102 or a third base station 103 as the serving base station. The first base station 101 is distant from the datum base station 100 by R1, the second base station 102 is distant from the datum base station 100 by R2 and the third base station 103 is distant from the datum base station 100 by R3, wherein R1 and R3 are smaller than R and R2 is larger than R. When the mobile station connects to the first base station 101 or the third base station 103, the user can have the homezone service provided by the network proprietor and have lower payment rating; if the mobile station selects the second base station 102 to be the serving base station, because it is not located in the homezone, the charge rating is higher. As shown in FIG. 1, the mobile station is originally located at a point P, and the first base station 101 is the serving base station. When the mobile station moves to a point Q, which is located at the edge of the communication range of the first base station 101, the C1 and C2 parameters of the second base station 102 and third base station 103 are measured for performing base station handover. The second base station 102 may be more suitable than the third base station 103 to be a new serving base station according to a comparison of the C1 and C2 parameters of the base stations because the second base station 102 is closer to the mobile station. Therefore, the mobile station will select the second base station 102 to be the new serving base station. However, the mobile station located at the point Q is still distant from the datum base station within the preset distance R and the third base station 103 can still provide signals with suitable intensity for the communication of the mobile station. According to present communication regulations, although the mobile station is located in the homezone, the user cannot have the homezone service provided by the network proprietor and lower charge rating, which results in users' loss.

### SUMMARY OF THE INVENTION

The invention is directed to a method for selecting a base station and communication system using the same. By using a weighed C2 parameter to reselect a serving base station, the homezone service can be provided suitably and reasonably.

According to a first aspect of the present invention, a method for selecting a base station is provided. The method is applied to a mobile station. The mobile station sets a preset distance corresponding to a datum base station. The method comprises selecting a first base station to be a serving base station; and obtaining a first C2 parameter of a second base station corresponding to the mobile station, and obtaining a second C2 parameter as a base for the mobile station in selecting the serving base station when a distance between the second base station and the datum base station is determined to be smaller than the preset distance, wherein the second C2 parameter is equal to the first C2 parameter plus a threshold value.

According to a second aspect of the present invention, a communication system is provided. The communication system comprises a datum base station, a mobile station, a first base station, and a second base station. The mobile station sets a preset distance corresponding to the datum base station. The first base station is served as a serving base station of the mobile station. The second base station has a distance smaller than the preset distance from the datum base station. The mobile station obtains a first C2 parameter of the second base station corresponding to the mobile station, the mobile station determines whether to select the second base station as the serving base station according to a second C2 parameter, and the second C2 parameter is equal to the first C2 parameter plus a threshold value.

The invention will become apparent from the following detailed description of the preferred but non-limiting embodiments. The following description is made with reference to the accompanying drawings.

### BRIEF DESCRIPTION OF THE DRAWINGS

FIG. 1 is a schematic diagram of a conventional homezone service.

FIG. 2A and FIG. 2B are a flow chart of the method for selecting a base station according to a preferred embodiment of the invention.

FIG. 3 is a comparison table of the first C2 parameters and second C2 parameters of several base stations according to the preferred embodiment of the invention.

### DETAILED DESCRIPTION OF THE INVENTION

The invention is directed to a method for selecting a base station and communication system using the same. By using the weighed C2 parameter to reselect the serving base station, the homezone service can be extended to provide the users with more rights and interests.

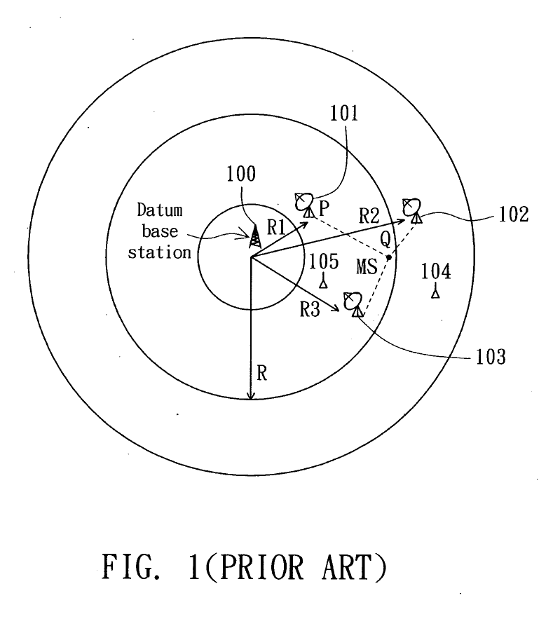

The method of the invention is applied to a communication system, such as the homezone service of FIG. 1. The communication system includes a datum base station 100, a mobile station and several base stations, such as a first base station 101, a second base station 102 and a third base station 103. The mobile station selects one of the base stations to be the serving base station and the other base stations adjacent to the serving base station are neighbor base stations. The mobile station sets a preset distance R corresponding to the datum base station 100 and the location of the mobile station distant from the datum base station 100 within the preset distance R forms the homezone. The broadcasting position coordinates of the serving base station are used for the mobile station to calculate the distance between the serving base station and the datum base station. When the distance between the serving base station and the datum base station is smaller the preset distance R, the serving base station provides the mobile station with a homezone service.

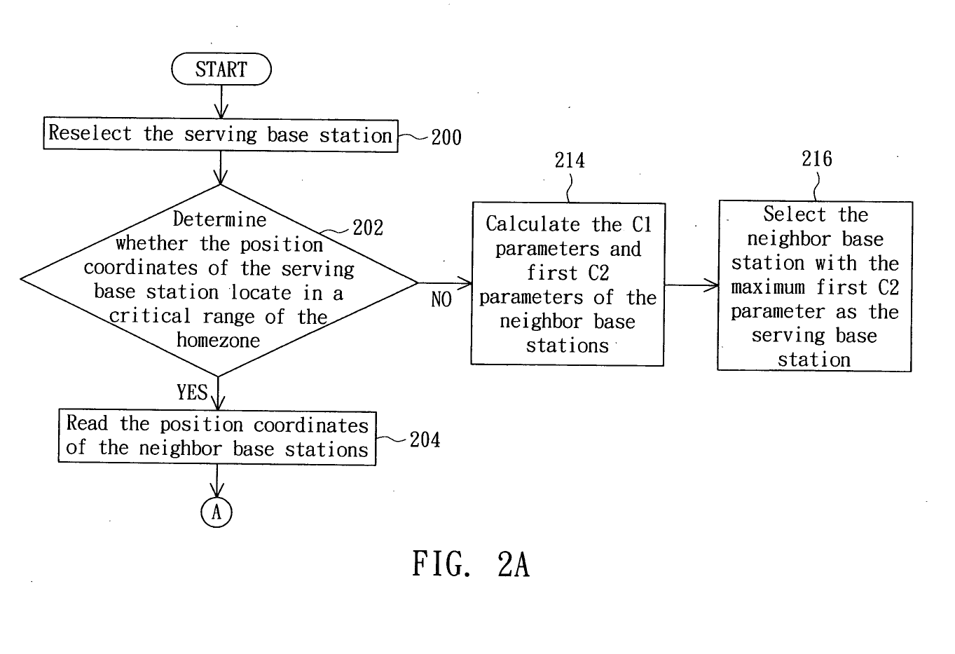

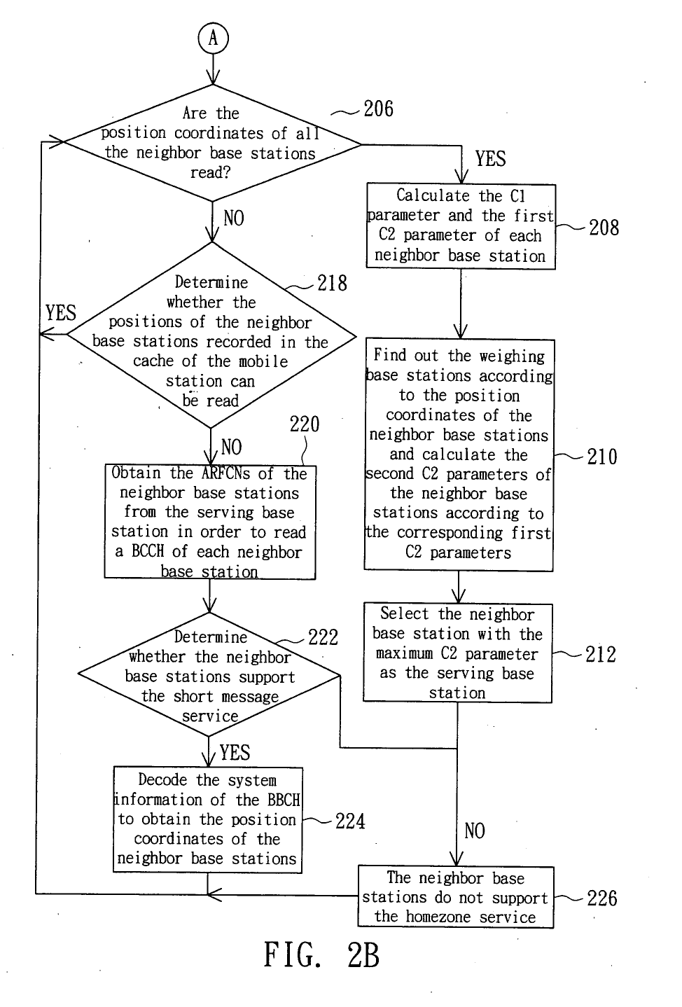

Referring to FIG. 2A and FIG. 2B, a flow chart of the method for selecting a base station according to a preferred embodiment of the invention is shown. When the user communicates with the serving base station through the mobile station, it may trigger the step 200 in which the mobile station has to reselect one of the neighbor base stations to be the serving base station due to poor signal reception or other factors.

In order to save power consumption, in step 202, the mobile station determines whether the present registered serving base station has its position coordinates located in a critical range of the homezone according to a critical value t. A lower limit value of the critical range is a multiplication R×t of the preset distance R and the critical value t. An upper limit value of the critical range is a multiplication (2-t)×R of the difference between 2 and the critical value t and the preset distance R. The critical value t is 0.8 for instance, and the critical range of the homezone is 0.8R˜1.2R.

If the position coordinates of the serving base station belong to the critical range of the homezone, in step 204, the mobile station obtains position coordinates of several neighbor base stations from a list of neighbor base stations in the serving base station. That is, the information of neighbor base stations is provided by the serving base station. Or the information can be read directly from the broadcasting information of the neighbor base stations. Following that, in step 206, the mobile station has to determine whether the position coordinates of all the neighbor base stations are read. If the mobile station has read the position coordinates of all the neighbor base stations, in step 208, the mobile station calculates the corresponding C1 parameter and first C2 parameter of each neighbor base station, wherein the first C2 parameter is the conventional C2 parameter.

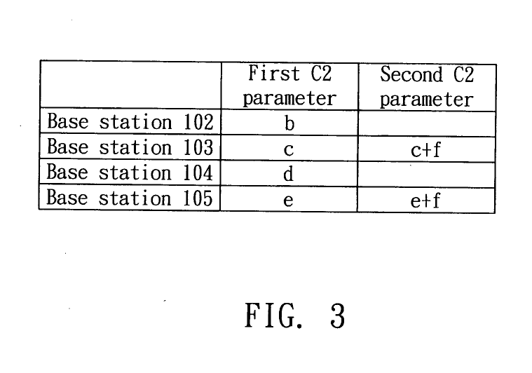

Next, in step 210, the mobile station calculates and finds out weighing base stations located in the homezone, which are distant from the datum base station 100 within the preset distance R. The mobile station adds the corresponding first C2 parameter of each weighing base station by a threshold value to become a second C2 parameter. In step 212, the mobile station selects the neighbor base stations with the maximum C2 parameter (the first C2 parameter or the second C2 parameter) to be the serving base station. That is, the C2 parameters of the weighing base stations in the neighbor base stations are the second C2 parameters and the C2 parameters of the other base stations in the neighbor base stations are the first C2 parameters. Referring to FIG. 3, a comparison table of the first C2 parameters and second C2 parameters of several base stations according to the preferred embodiment of the invention is shown. As shown in FIG. 1 and FIG. 3, when the mobile station moves to the point Q, the neighbor base stations are base stations 102, 103, 104 and 105. The mobile station first measures the first C2 parameters of the neighbor base stations to be b, c, d and e, and then calculates and determines the base stations 103 and 104 to be located in the homezone according to the coordinates of the neighbor base stations. Therefore, the base stations 103 and 104 are set to be weighing base stations and the corresponding first C2 parameter is added by a threshold value f to become the second C2 parameter. Then, the mobile station determines the following selection of the serving base station according to a maximum of the C2 parameters b, (c+f), d and (e+f).

Besides, in step 202, if the position coordinates of the serving base station do not belong to the critical range of the homezone, in step 214, the mobile station calculates the corresponding C1 parameters and first C2 parameters of all the neighbor base stations and in step 216, the mobile station selects the neighbor base station with the largest first C2 parameter to be the serving base station.

Moreover, in step 206, if the mobile station cannot read the position coordinates of a certain neighbor base station, the mobile station cannot calculate the corresponding C1 parameters and first C2 parameters of all the neighbor base station. Therefore, in step 218, the mobile station searches the position coordinates of all the neighbor base stations transmitted from the datum base station 100 as communicating with the datum base station 100 before and recorded in the cache of the mobile station in order to read the position coordinates of the neighbor base stations.

However, if the mobile station still cannot read the address of the neighbor base stations in step 218, in step 220, the mobile station reads a broadcast control channel (BCCH) of each neighbor base station. It should be noted that the present regulations of the global mobile communication system standard mention only how the mobile station receives broadcast information of the serving base station but not the mechanism of the mobile station receiving the broadcast information of the neighbor base stations. In the embodiment, a list of neighbor base stations is read from the serving base station to obtain an allocate radio frequency channel number (ARFCN) of each neighbor base station and the broadcast control channels of the neighbor base stations are read from the ARFCNs.

The broadcast control channels of the neighbor base stations carry system information (SI). Through the system information SI, the mobile station can read information broadcasted by the neighbor base stations. Therefore, in step 222, the mobile station determines whether the neighbor base stations support the short message service cell broadcast (SMSCB). If the neighbor base stations support the SMSCB, in step 224, the mobile station decodes the system information Si of the BCCH to obtain the address of each neighbor base station and then the mobile station executes the step 206.

If the neighbor base station does not support the SMSCB, in step 226, the mobile station determines the neighbor base station does not support the homezone service and does not try again to read the addresses of the neighbor base stations and executes the step 208 after the step 206.

In the step 202 of the above embodiment, a critical range of the homezone is defined. If the mobile station is not located in the critical range, it represents the mobile station is distant from the boundary of the homezone, and thus, the present flow of reselecting the serving base station, that is, the steps 214˜216 of FIG. 2A can be used. Moreover, the mobile station does not need to decode the BCCHs of the neighbor base stations, and thus can reduce power consumption. If the mobile station is located in the critical range, it represents the mobile station is close to the boundary of the homezone, that is, located in an indefinite region and the method goes from the step 202 to the step 204.

Besides, in the present regulations of global mobile communication system standard, the mobile station has to read the BCCH of each neighbor base station every 5 minutes. Owing that the mobile station will not move too much distance in a specific time, the position coordinates of the neighbor base station will not change very often. Therefore, in practical application, the mobile station reads the position coordinates of the neighbor base stations and records them in the cache, and thus in step 218, the mobile can read the position coordinates of the neighbor base stations from the cache without need to decode again the BCCH of each neighbor base station, which helps to save time.

In the method for selecting a base station and communication system using the same disclosed by the above embodiment of the invention, the weighed C2 parameters are used for reselecting the serving base station in order to extend the homezone service and provide the users with more rights and interests.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for selecting a base station, applied to a mobile station, the mobile station setting a preset distance corresponding to a datum base station, the method comprising:
selecting a first base station to be a serving base station; and
obtaining a first C2 parameter of a second base station corresponding to the mobile station, and obtaining a second C2 parameter as a base for the mobile station in selecting the serving base station when a distance between the second base station and the datum base station is determined to be smaller than the preset distance, wherein the second C2 parameter is equal to the first C2 parameter plus a threshold value.

2. The method according to claim 1, wherein the first base station broadcasts first position coordinates for calculating a distance between the first base station and the datum base station and when the distance between the first base station and the datum base station is smaller than the preset distance, the first base station provides the mobile station with a homezone service.

3. The method according to claim 1, wherein the second base station broadcasts second position coordinates for calculating the distance between the second base station and the datum base station.

4. The method according to claim 3, wherein the step of calculating the distance between the second base station and the datum base station comprises determining whether the second base station is located within a critical range of the preset distance according to a critical value, wherein a lower limit value of the critical range is multiplication of the preset distance and the critical value, and an upper limit value of the critical range is twice of a difference between the preset distance and the lower limit value of the critical range.

5. The method according to claim 1, wherein the second base station is a neighbor base station of the first base station, the first base station broadcasts position coordinates of the neighbor base station to the mobile station.

6. The method according to claim 5, wherein when the mobile station cannot read the position coordinates of the neighbor base station, the mobile station reads the position coordinates of the neighbor base station recorded in a memory of the mobile station.

7. The method according to claim 6, further comprising:
when the mobile station does not read the position coordinates of the neighbor base station recorded in the memory of the mobile station, reading a broadcast control channel (BCCH) of the neighbor base station via the mobile station;
determining whether the neighbor base station supports a short message service via the mobile station; and
when the neighbor base station supports the short message service, decoding a system information of the broadcast control channel to obtain the position coordinates of the neighbor base station.

8. The method according to claim 7, wherein when the neighbor base station does not support the short message service, the neighbor base station does not support a homezone service.

9. The method according to claim 1, further comprising:
obtaining a third C2 parameter of a third base station corresponding to the mobile station and selecting the base station corresponding to a larger one of the third C2 parameter and the second C2 parameter to be the serving base station when a distance between the third base station and the datum base station is larger than the preset distance.

10. A communication system, comprising:
a datum base station;
a mobile station, for setting a preset distance corresponding to the datum base station;
a first base station, served as a serving base station of the mobile station; and
a second base station, having a distance smaller than the preset distance from the datum base station, wherein the mobile station obtains a first C2 parameter of the second base station corresponding to the mobile station, the mobile station determines whether to select the second base station as the serving base station according to a second C2 parameter, and the second C2 parameter is equal to the first C2 parameter plus a threshold value.

11. The communication system according to claim 10, wherein the first base station broadcasts first position coordinates for calculating a distance between the first base station and the datum base station and when the distance between the first base station and the datum base station is smaller than the preset distance, the first base station provides the mobile station with a homezone service.

12. The communication system according to claim 10, wherein the second base station broadcasts second position coordinates for calculating the distance between the second base station and the datum base station.

13. The communication system according to claim 12, wherein whether the second base station is located within a critical range of the preset distance is determined according to a critical value, and a lower limit value of the critical range is multiplication of the preset distance and the critical value, and an upper limit value of the critical range is twice of a difference between the preset distance and the lower limit value of the critical range.

14. The communication system according to claim 10, wherein the second base station is a neighbor base station of the first base station, and the first base station broadcasts position coordinates of the neighbor base station to the mobile station.

15. The communication system according to claim 14, wherein when the mobile station cannot read the position coordinates of the neighbor base station, the mobile station determines whether the position coordinates of the neighbor base station recorded in a memory of the mobile station can be read.

16. The communication system according to claim 15, wherein when the mobile station does not read the position coordinates of the neighbor base station recorded in the memory of the mobile station, the mobile station reads a broadcast control channel (BCCH) of the neighbor base station, determines whether the neighbor base station supports a short message service, and decodes a system information of the broadcast control channel to obtain the position coordinates of the neighbor base station when the neighbor base station supports the short message service.

17. The communication system according to claim 16, wherein when the neighbor base station does not support the short message service, the neighbor base station does not support a homezone service.

18. The communication system according to claim 10, further comprising:
a third base station, having a third C2 parameter corresponding to the mobile station, wherein the mobile station selects the base station corresponding to a larger one of the third C2 parameter and the second C2 parameter to be the serving base station when a distance between the third base station and the datum base station is larger than the preset distance.
